(19) United States
(12) Patent Application Publication
(10) Pub. No.: US 2013/0010089 A1
(43) Pub. Date: Jan. 10, 2013

(54) IMAGE DISPLAY SYSTEM CAPABLE OF AUTOMATIC 2D/3D SWITCHING

(75) Inventors: Shingo Maeda, Osaka-shi (JP); Yuki Omiya, Osaka-shi (JP)

(73) Assignee: Sharp Kabushiki Kaisha, Osaka (JP)

(21) Appl. No.: 13/635,267

(22) PCT Filed: Mar. 14, 2011
(86) PCT No.: PCT/JP2011/055925

§ 371 Date: Sep. 14, 2012

(30) Foreign Application Priority Data
Mar. 19, 2010 (JP) 2010-064206
Mar. 11, 2011 (JP) 2011-053841

(51) Int. Cl. H04N 13/04

(52) U.S. Cl. 348/53; 348/E13.075

(57) ABSTRACT

In a 3D television viewed using 3D viewing glasses, a 3D image and a non-3D image can be automatically switched. A 3D image can be displayed when the viewer removes 3D viewing glasses from a special seat, when an image sensor equipped on 3D viewing glasses worn by the viewer detects a motion on the television screen, when a television set is equipped with a camera and determines from an image of the camera that the viewer wears 3D viewing glasses, or when the viewer opens the arms of 3D viewing glasses to wear the glasses.

### FIELD OF THE INVENTION

The present invention relates to a technology to automatically switch a 3D image and a non-3D image in a 3D television capale of selecting and displaying the 3D image viewable by using special 3D image viewing glasses or the non-3D normal image.

### BACKGROUND ART

Some methods for viewing stereoscopic images using parallax between right and left eyes have been known (hereinafter, the image is referred to as ‘3D image’ and the other image is referred to as ‘non-3D image’). Such images can be viewed by a method using special glasses or by a method without using the glasses.

For example, glasses having a liquid-crystal shutter can be used in the method using special glasses. It is necessary for causing the parallax to show a right-eye image for the right eye, and a left-eye image for the left eye, and in this method, the right-eye and left-eye images are alternatively displayed on the television screen. The viewer views the images wearing the glasses having a liquid-crystal shutter, and in the glasses having a liquid-crystal shutter. In the glasses having a liquid-crystal shutter, when the left-eye image is displayed on the screen, a right-eye glass is closed, and when the right-eye image is displayed on the screen, a left-eye glass is closed. Therefore, shutter action to switching the right-eye and left-eye images is performed synchronized with the right/left switching of the monitor screen. In the synchronization, for example, the television transmits the synchronization signal, and the glasses having a liquid-crystal shutter receive the signal and operate the open/close of the shutter.

Meanwhile, the glasses having a liquid-crystal shutter are not necessary when viewing the non-3D image. In many 3D television apparatus using the glasses having a liquid-crystal shutter, the non-3D image can also be viewed, and when switching the 3D/non-3D image, it is necessary to wear or remove the glasses having a liquid-crystal shutter, and to switch a display of the screen. Moreover, in order to save the power upon shutter open/close, it is necessary to perform power on/off of the glasses having a liquid-crystal shutter.

In Japanese Patent No. 3172407, glasses having a liquid-crystal shutter to remove such burden of operations are disclosed. The glasses having a liquid-crystal shutter of Japanese Patent No. 3172407 are worn on the head using a headband, and when viewing the non-3D image, just by flipping a frame of the glasses up to a forehead, the shutter of the glasses having a liquid-crystal shutter is powered off, and switching from 3D image to non-3D image in the television is automatically performed.

As another type of the 3D glasses, a film-type pattern retarder using a polarizing film is applicable. In this type of glasses, the left-eye and right-eye images are alternatively displayed on a liquid-crystal panel line by line. The left-eye and right-eye images are displayed on the screen after passing the polarizing film for polarizing in an orthogonal direction, and when the viewer watches the images wearing the glasses having polarizing film, the left-eye image can only be viewed by the left eye, and the right-eye image can only be viewed by the right eye, thereby enabling the 3D image viewing (Japanese Unexamined Patent Application Publication No. 2009-301039).

Patent Reference 1: Japanese Patent No. 3172407

Patent Reference 2: Japanese Unexamined Patent Application Publication No. 2009-301039

### DISCLOSURE OF THE INVENTION

### Problems that the Invention Tries to Solve

In Japanese Patent No. 3172407, the switching of screen is possible without removing the glasses having a liquid-crystal shutter. However, as the glasses having a liquid-crystal shutter are far heavier than normal glasses, the viewer feels the heaviness upon viewing the 3D image. Moreover, when using the headband in Japanese Patent No. 3172407 upon viewing the non-3D image, the viewer feels more burden of the glasses. Although it is possible to remove the glasses when viewing the non-3D image, this makes the function of flipping redundant.

Therefore, it is more prefereble for the viewer to switch the 3D/non-3D image on the assumption that the glasses having a liquid-crystal shutter are removed when viewing the non-3D image, thereby improving user-friendliness This is not limited to the glasses having a liquid-crystal shutter. In the case of the glasses of the film-type pattern retarder using the polarizing film, or other types of the 3D image viewing glasses, it is more prefereble for the viewer to switch the 3D/non-3D image on the assumption that the glasses having a liquid-crystal shutter are removed when viewing the non-3D image.

### Means for Solving the Problems

In order to solve the above deficiencies, in an aspect of the invention, the switching 3D/non-3D image is automatically executed on the assumption that the glasses having a liquid-crystal shutter are removed when viewing the non-3D image.

A first aspect of the invention according to claim 1 is an image display system where a seat for placing a 3D image viewing glasses is provided, and switching of a television screen is executed upon removing the 3D image viewing glasses from the seat. Specifically, the first aspect is an image display system, comprising a 3D image viewing glasses; a seat for glasses for placing the 3D image viewing glasses; and a first image display apparatus for viewing via the 3D image viewing glasses, wherein the seat for glasses further comprises a detection circuit, detecting whether the 3D image viewing glasses have been placed, and a first signal transmission circuit, transmitting a 3D image display signal for displaying the 3D image when the detection result by the detection circuit indicates that the 3D image viewing glasses have not been placed, and wherein the first image display apparatus further comprises a first 3D image display signal reception circuit, receiving the 3D image display signal, and a first 3D image display circuit, displaying the 3D image when the first 3D image display signal reception circuit has received the 3D image display signal.

A second aspect of the invention according to claim 2 based on the first aspect is an image display system where the 3D image viewing glasses have a chargeable battery for supplying power for open/close action of the shutter, and when placing the 3D image viewing glasses on the seat, the battery can be charged. Specifically, the second aspect is the image display system according to claim 1, wherein the 3D image viewing glasses have a liquid-crystal shutter, and further comprises a first connection terminal for electric connection to the seat for glasses when the 3D image viewing glasses have been placed, and a chargeable battery being connected with the first connection terminal, and wherein the seat for glasses further comprises a second connection terminal for electric connection to the first connection terminal of the 3D image viewing glasses, and a charging circuit, supplying power to the battery when the connection between the first connection terminal and the second connection terminal is established, and wherein the detection circuit detects that the 3D image viewing glasses have been placed when the connection between the first connection terminal and the second connection terminal has been established.

A third aspect of the invention according to claim 3 is an image display system where 3D image viewing glasses have an image sensor in front thereof, and when a viewer wears the 3D image viewing glasses, the image sensor detects variation of image on the television screen, thereby switching the image on the screen to the 3D image. Specifically, the third aspect is the image display system, comprising 3D image viewing glasses; and a second image display apparatus for viewing via the 3D image viewing glasses, wherein the 3D image viewing glasses further comprises an image sensor, an image movement determination circuit, determining whether an image imaged by the image sensor includes movement, and a second signal transmission circuit, transmitting a 3D image display signal to display a 3D image, when the image movement determination circuit has determined that the image has included the movement, and wherein the second image display apparatus further comprises a second 3D image display signal reception circuit, receiving the 3D image display signal, and a second 3D image display circuit, displaying the 3D image when the second 3D image display signal reception circuit has received the 3D image display signal.

A fourth aspect of the invention according to claim 4 is an image display system where the television has a sensor, and when the sensor recognizes that the 3D image viewing glasses have been included in an image imaged by the sensor, switching of the television display to the 3D image is executed. Specifically, the fourth aspect is the image display system, comprising 3D image viewing glasses; and a third image display apparatus for viewing via the 3D image viewing glasses, wherein the third image display apparatus further comprises an image sensor, an image recognition circuit, determining whether an image imaged by the image sensor includes identification information of the 3D image viewing glasses, and a third 3D image display circuit, displaying the 3D image, when the image recognition circuit has determined that the image has included the identification information of the 3D image viewing glasses.

A fifth aspect of the invention according to claim 5 is an image display system where 3D image viewing glasses have arms, and when the arms are opened, switching of the television display to the 3D image is executed. Specifically, the fifth aspect is the image display system, comprising 3D image viewing glasses having arms; and a fourth image display apparatus for viewing via the 3D image viewing glasses, wherein the 3D image viewing glasses having arms further comprises a sensor, detecting whether the arms are closed, and a fourth signal transmission circuit, transmitting a 3D image display signal to display a 3D image, when the sensor has detected that the arms have not been closed, and wherein the fourth image display apparatus further comprises a fourth 3D image display signal reception circuit, receiving the 3D image display signal, and a fourth 3D image display circuit, displaying the 3D image when the fourth 3D image display signal reception circuit has received the 3D image display signal.

### Effects of the Invention

According to the first aspect, the image display system, where the switching of the 3D/non-3D image of the television screen is automatically executed upon removing the 3D image viewing glasses from the seat, is provided.

According to the second aspect, the image display system, where the 3D image viewing glasses have a chargeable battery for supplying power for open/close action of the shutter, and when placing the 3D image viewing glasses on the seat, the battery is automatically charged, and when removing the 3D image viewing glasses from the seat, the switching of the 3D/non-3D image of the television screen is automatically executed, is provided.

According to the third and fourth aspects, the image display system, where the switching of the 3D/non-3D image of the television screen is automatically executed just by wearing the 3D image viewing glasses and facing to the television screen, is provided.

According to the fifth aspect, the image display system, where the switching of the 3D/non-3D image of the television screen is automatically executed just by opening/closing the arms of the 3D image viewing glasses, which is an action naturally done upon wearing/removing the glasses, is provided.

### BRIEF DESCRIPTION OF THE DRAWINGS

FIG. 1 is a conceptual diagram of an image display system of a first embodiment.

FIG. 2 is a functional block diagram of the image display system of the first embodiment.

FIG. 3A is a flowchart showing processes in the image display system of the first embodiment.

FIG. 3B is a flowchart showing processes in a continuous type of the image display system of the first embodiment.

FIG. 4 is a functional block diagram of an image display system of a second embodiment.

FIG. 5 is a diagram showing examples of a first and a second connection terminals of the second embodiment.

FIG. 6 is a conceptual diagram of an image display system of a third embodiment.

FIG. 7 is a functional block diagram of the image display system of the third embodiment.

FIG. 8 is a flowchart showing processes in the image display system of the third embodiment.

FIG. 9 is a conceptual diagram of an image display system of a fourth embodiment.

FIG. 10 is a functional block diagram of the image display system of the fourth embodiment.

FIG. 11 is a flowchart showing processes in the image display system of the fourth embodiment.

FIG. 12 is a conceptual diagram of an image display system of a fifth embodiment.

FIG. 13 is an enlarged view of connection terminals of arms of a 3D image viewing glasses of the fifth embodiment.

FIG. 14 is a flowchart showing processes in the image display system of the fifth embodiment.

### DETAILED DESCRIPTION OF THE INVENTION

The first embodiment will mainly describe the first aspect. The second embodiment will mainly describe the second aspect. The third embodiment will mainly describe the third aspect. The fourth embodiment will mainly describe the fourth aspect. The fifth embodiment will mainly describe the fifth aspect.

### First Embodiment

### Concept of First Embodiment

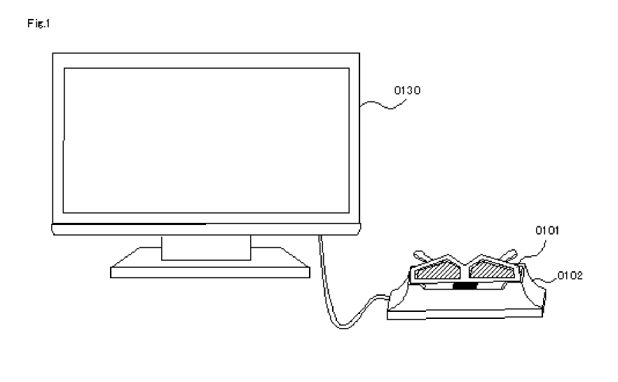

FIG. 1 is a conceptual diagram of an image display system of a first embodiment. A first image display apparatus 0103 is a television capable of displaying both 3D image and non-3D image, and when not viewing the 3D image, 3D image viewing glasses 0101 are placed on a seat for glasses 0102.

When placing the 3D image viewing glasses on the seat, if the television is powered on, the non-3D image is displayed on the screen. When viewing the 3D image, it is necessary for the viewer to wear the 3D image viewing glasses. When the viewer removes the 3D image viewing glasses from the seat for glasses, the switching from the non-3D image to the 3D image of the television screen is automatically executed.

### Configuration of First Embodiment

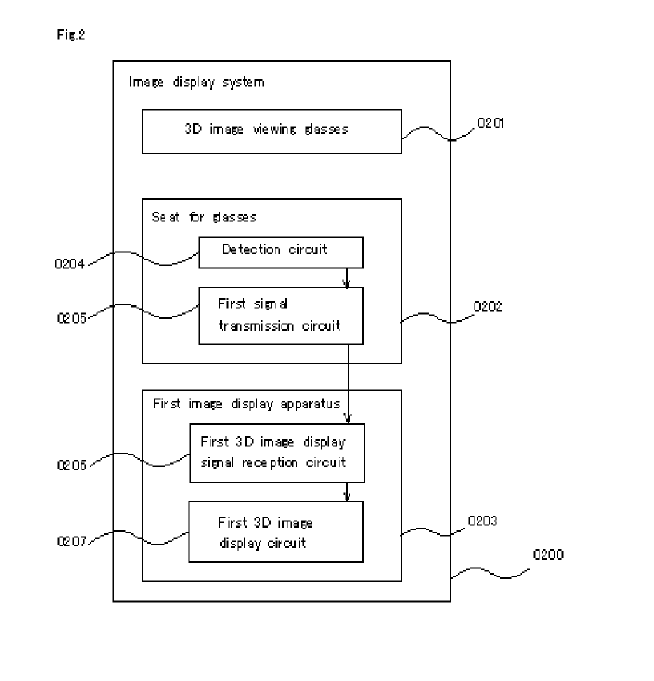

FIG. 2 is a functional block diagram of the image display system of the first embodiment. An ‘image display system’ 0200 of the first embodiment comprises ‘3D image viewing glasses’ 0201, a ‘seat for glasses’ 0202, and a ‘first image display apparatus’ 0203. The seat for glasses comprises a ‘detection circuit’ 0204, and a ‘first signal transmission circuit’ 0205. The first image display apparatus comprises a ‘first 3D image display signal reception circuit’ 0206, and a ‘first 3D image display circuit’ 0207.

The ‘3D image viewing glasses’ are used for ‘3D image viewing’. For example, the 3D image viewing glasses of the first embodiment are glasses having a liquid-crystal shutter, and is synchronized with the television via wireless communication. Specifically, synchronization signal of infrared communication etc. from the television is received, and on the basis of this signal, the open/close of the shutter is synchronized. The power source for operating the shutter etc. of the 3D image viewing glasses may be a dry-cell battery or a chargeable battery. The 3D image viewing glasses are not limited to this example. In the case of the film-type pattern retarder, glasses having polarizing film may be used, of in the case of the anaglyph type, red/blue glasses may be used.

The ‘seat for glasses’ is a seat for ‘placing the 3D image viewing glasses’. The seat is called as a ‘cradle’ etc, and widely used for storing a portable electronic device, charging, and data exchange and synchronization with a personal computer. The seat for glasses of the present invention is also used as the storage place for the 3D image viewing glasses, and used for the switching of the 3D/non-3D image of the television screen. The power for the seat for glassses may be supplied directly from a home power source, or may be supplied from the first image display apparatus.

The ‘detection circuit’ is for ‘detecting whether the 3D image viewing glasses have been placed’. The detection is executed, for example, by a method where a switch is provided at the portion for placing the 3D image viewing glasses, and when placing the 3D image viewing glasses on the seat, the switch is pressed from the weight of the glasses. Moreover, a micro chip is provided to the 3D image viewing glasses, and when placing the 3D image viewing glasses on the seat, a reader in the seat reads the microchip. Moreover, a pair of electrodes is provided at the portion for placing the 3D image viewing glasses, and when placing the 3D image viewing glasses on the seat, the electrodes are in contact with a metal portion of the 3D image viewing glasses, and energizing between the electrodes is detected.

The ‘first image display apparatus’ is a display apparatus capable of displaying the 3D image. The television set with 3D display function is recently sold for home use.

The ‘first signal transmission circuit’ has a function of ‘transmitting a 3D image display signal for displaying the 3D image when the detection result by the detection circuit indicates that the 3D image viewing glasses have not placed’. The ‘first 3D image display signal reception circuit’ has a function of ‘receiving the 3D image display signal’. The ‘first 3D image display circuit’ has a function of displaying the 3D image when the first 3D image display signal reception circuit has received the 3D image display signal’. The first signal transmission circuit may transmit the 3D image display signal at the point of change of the detection result from ‘being placed’ to ‘not being placed’ (hereinafter, referred to as ‘instantaneous type’), or may continuously transmit the signal while the detection result indicates ‘not being placed’ (hereinafter, referred to as ‘continuous type’). Moreover, in the case of the instantaneous type, the first transmission circuit may transmit a non-3D image display signal at the point of the change of the detection result from ‘being placed’ to ‘not being placed’. In this case, the first 3D image display signal reception circuit further receiving the non-3D image display signal, and the first 3D image display circuit displays the non-3D image when the first 3D image display signal reception circuit receives the non-3D image display signal. In the case of the continuous type, the first 3D image display circuit may display the non-3D image when the first 3D image display signal reception circuit has not received the 3D image display signal. Moreover, when the first transmission circuit continuously transmits the non-3D image display signal while the detection result indicates ‘being placed’, and the first 3D image display signal reception circuit receives the non-3D image display signal, the first 3D image display circuit may display the non-3D image when the first 3D image display signal reception circuit receives the non-3D image display signal.

Note that in the above case, the terms ‘may display’ means that display of the 3D image is limited to the case of receiving the broadcast of the 3D image or viewing the 3D image DVD etc, and when not receiving such images etc, the 3D image is not displayed.

A plurality of 3D image viewing glasses and seats for glasses may be used for one television. In this case, when receiving the 3D image display signal from at least one of the seats for glasses, the 3D image display may be executed. Moreover, in the above configuration using the non-3D image display signal, when one of the seats transmits the 3D image display signal and other seats transmit the non-3D image display signals, the 3D image display may be executed.

Communication between the first signal transmission circuit of the seat for glasses and the first 3D image display signal reception circuit of the first image display apparatus may be executed via wireless or wired communication. Advantages of the wired communication are stability of communication with less radio disturbance, and no need for independent power source by using a power cable for receiving power from the television to the seat. An advantage of the wireless communication is to place the seat remotely from the television.

### Processing Flow of First Embodiment

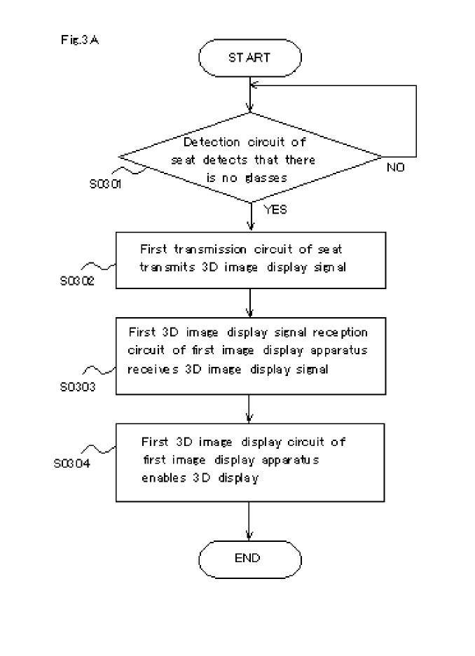

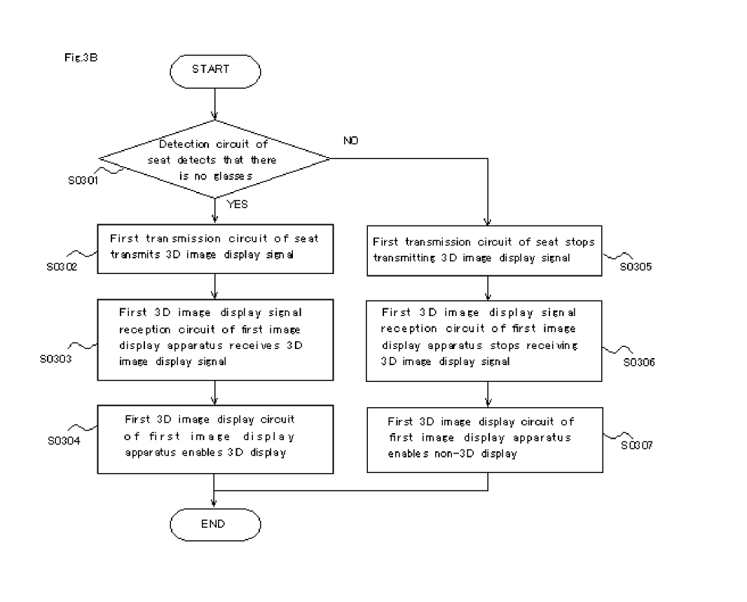

FIG. 3A is a flowchart showing processes in the image display system of the first embodiment. At the outset, when the viewer removes the 3D image viewing glasses from the seat for glasses, the detection circuit of seat detects that there are no glasses (step S0301), and the first transmission circuit of the seat transmits the 3D image display signal (step S0302). Subsequently, the first 3D image display signal reception circuit of the first image display apparatus receives the 3D image display signal (step S0303), and the first 3D image display circuit of the first image display apparatus enables 3D display (step S0304).

FIG. 3B is a flowchart showing processes in a continuous type of the image display system of the first embodiment. The process in the steps 0301 to 0304 is the same as that in FIG. 3A. Note that transmission in this process is continuously executed. When the viewer places the 3D image viewing glasses on the seat for glasses, the detection circuit of the seat stops detection that there are no glasses (step S0301), and the first transmission circuit of the seat stops transmitting the 3D image display signal (step S0305). Subsequently, the first 3D image display signal reception circuit of the first image display apparatus stops receiving the 3D image display signal (step S0306), and the first 3D image display circuit of the first image display apparatus stops the 3D display and switching of the television display to the non-3D image is executed (step S0307).

According to the first aspect, the image display system where the switching of the 3D/non-3D image of the television screen is automatically executed just by removing the 3D image viewing glasses from the seat, is provided.

### Second Embodiment

### Concept of Second Embodiment

Some of the 3D image viewing glasses need an independent power source. For example, the glasses having a shutter require power to be supplied to a circuit for operating open/close of the liquid-crystal shutter, and normally, a dry-cell battery built in the glasses having a shutter, or a chargeable battery is used as the poser source. The second aspect of the invention based on the first aspect is an image display system where the 3D image viewing glasses are glasses having a liquid-crystal shutter having a chargeable battery, and when placing the 3D image viewing glasses on the seat, the battery can be charged.

### Configuration of Second Embodiment

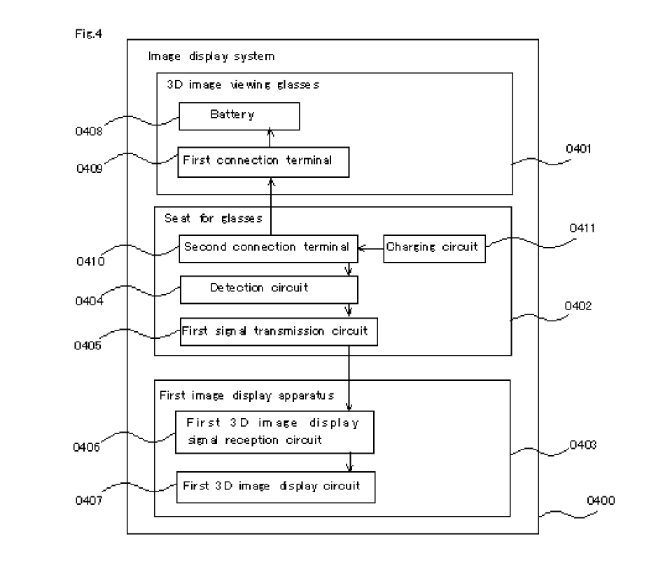

FIG. 4 is a functional block diagram of the image display system of the second embodiment. An ‘image display system’ 0400 of the second embodiment comprises ‘3D image viewing glasses’ 0401, a ‘seat for glasses’ 0402, and a ‘first image display apparatus’ 0403. The seat for glasses further comprises a ‘battery’ 0408 and a ‘first connection terminal’ 0409. The seat for glasses further comprises a ‘second connection terminal’ 0410, and a ‘charging circuit’ 1411. The first image display apparatus further comprises a ‘first 3D image display signal reception circuit’ 0406, and a ‘first 3D image display circuit’ 0407.

The 3D image viewing glasses of the second embodiment are glasses having a liquid-crystal shutter. The ‘first connection terminal’ of the 3D image viewing glasses is a connection terminal ‘for electric connection to the seat for glasses when the 3D image viewing glasses are placed’, and the ‘second connection terminal’ of the seat for glasses is connection terminal ‘for electric connection to the first connection terminal of the 3D image viewing glasses’. Both terminals are mutually detachable, and computer connection terminal such as USB connector etc. or connection terminal for communication such as RE-232C etc. may be used. Moreover, non-standard connection terminals may be used.

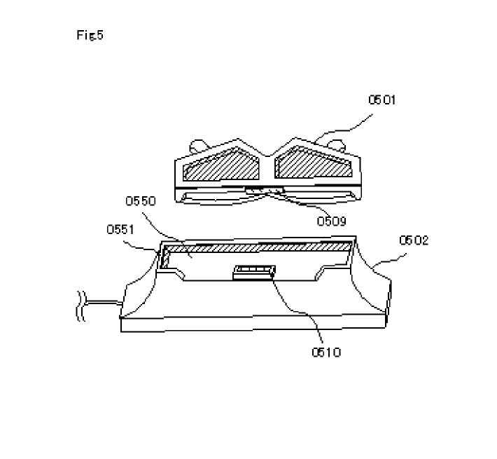

FIG. 5 is a diagram showing examples of a first and a second connection terminal of the second embodiment. The first connection terminal 0509 of female type is placed at the upper central portion of the 3D image viewing glasses 0501. The second connection terminal 0510 of male type is placed at the upper central portion of the seat for glasses 0502. The external wall 0551 to stably support the 3D image viewing glasses placed on the seat is formed around the upper tray 0550 of the seat for glasses. When placing the 3D image viewing glasses on the seat for glasses, the upper frame and the closed arms of the 3D image viewing glasses are supported by the external wall and are fixed, and the first and second connection terminals are provided to the 3D image viewing glasses and the seat for glasses, such that the connection terminals are smoothly connected.

The ‘battery’ is a ‘chargeable battery’ for supplying efficient power to the 3D image viewing glasses. The battery is ‘connected to the first connection terminal’.

The ‘charging circuit’ detects connection with the battery ‘when the connection between the first connection terminal and the second connection terminal is established’, and when charging is necessary for the battery, starts and controls charging. While charging, the ‘charging circuit’ ‘supplies power to the battery’. The power is supplied from the charging circuit to the battery via the first connection terminal, and the second connection terminal.

The detection circuit ‘detects that the 3D image viewing glasses are placed when the connection between the first connection terminal and the second connection terminal is established’.

Other configurations are the same as those of the first embodiment. The processing flow of the switching of the 3D/non-3D image of the television screen is the same as that of the first embodiment except the detection of the connection between the first and second connection terminals.

More specifically, in the image display system of the second embodiment, for example, the 3D image viewing glasses further comprise a ‘shutter glass’, a ‘shutter control circuit’, a ‘synchronization signal reception circuit’, and a ‘main power control circuit’, and the first image display apparatus further comprises a ‘synchronization signal transmission circuit’.

A pair of ‘shutter glasses’ of the 3D image viewing glasses is provided for right and left eyes. The ‘shutter control circuit’ controls the open/close of the shutter of the pair of ‘shutter glasses’ by synchronizing with the synchronization signal received by the ‘synchronization signal reception circuit’. The ‘synchronization signal transmission circuit’ of the first image display apparatus transmits the synchronization signal when the first 3D image display circuit can display the 3D image.

The ‘main power control circuit’ turns on the main power of the 3D image viewing glasses when the synchronization signal reception circuit receives the synchronization signal. In the state of power on, the power from the battery is supplied to the shutter glass and the shutter control circuit. The power is constantly supplied to the synchronization signal reception circuit and the main power control circuit. According to this configuration, the power control of the 3D image viewing glasses can be executed along with the switching of the 3D/non-3D image by the first image display apparatus, thereby reducing the burden of the power on/off of the 3D image viewing glasses, and saving the power. Moreover, a special signal for controlling the power of the 3D image viewing glasses may be used in place of the synchronization signal.

According to the second aspect, the image display system, where just by placing/removing the 3D image viewing glasses on or from the seat, the battery is automatically charged, and the switching of the 3D/non-3D image is automatically executed, is provided.

### Third Embodiment

### Concept of Third Embodiment

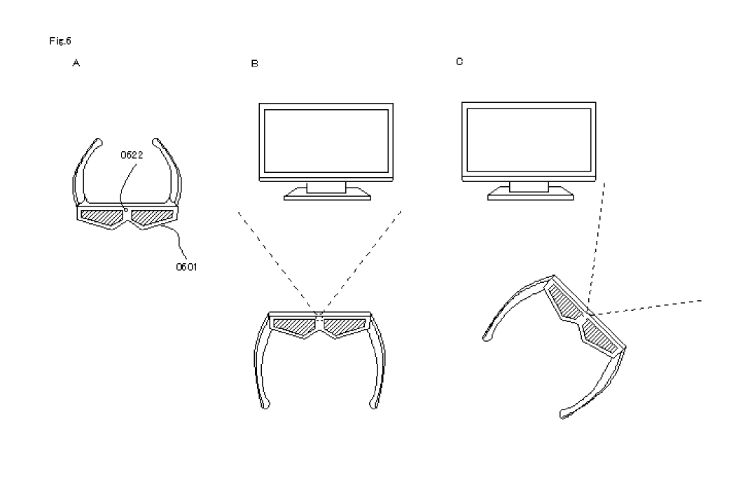

FIG. 6 is a conceptual diagram of an image display system of a third embodiment. In the image display system of the third embodiment, 3D image viewing glasses 0601 comprise an image sensor 0622 in front thereof (FIG. 6A). When a viewer wears the 3D image viewing glasses, the image sensor detects variation of image on the television screen, thereby switching of the image on the screen to the 3D image (FIG. 6B). When the viewer places the 3D image viewing glasses, it is determined that there is no variation of image on the television screen in the sensing range of the sensor, and the switching of the television display to the 3D image is executed (FIG. 6C). Note that although the image sensor is provided in front of the 3D image viewing glasses and cannot be viewed from the back side, in FIGS. 6B and 6C, the image sensor is illustrated by perforated line in the 3D image viewing glasses for explanation.

### Configuration of Third Embodiment

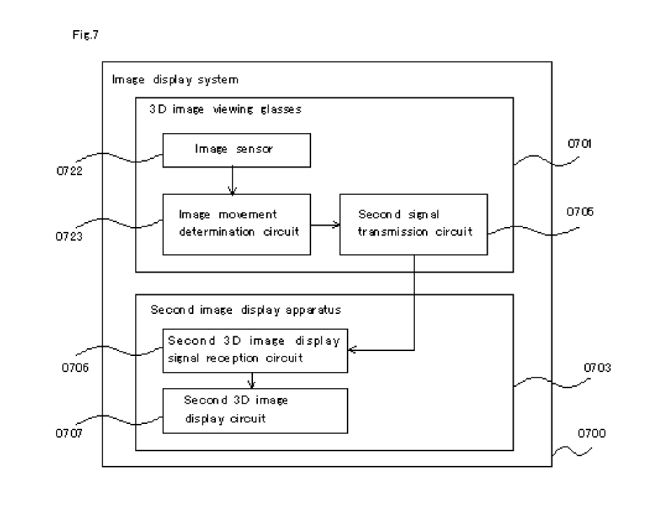

FIG. 7 is a functional block diagram of the image display system of the third embodiment. An ‘image display system’ 0700 of the third embodiment comprises ‘3D image viewing glasses’ 0701, a ‘seat for glasses’ 0702, and a ‘second image display apparatus’ 0703. The 3D image viewing glasses further comprise an ‘image sensor’ 0722, an ‘image movement determination circuit’ 0723, and a ‘second transmission circuit’ 0705. The second image display apparatus further comprises a ‘second 3D image display signal reception circuit’ 0706, and a ‘second 3D image display circuit’ 0707.

The ‘image sensor’ is a photoelectric conversion element for converting an image into electric signal, and an example thereof includes a solid-state image sensing device such as a CCD image sensor, a CMOS image sensor, and a photodiode.

The ‘image movement determination circuit’ determines whether an image imaged by the image sensor includes movement. The technology for determining whether an object in an image moves has been used for a monitor camera etc, and this is applicable to the image display system. Specifically, a first method for detecting simple movement irrespective of television image is applicable. In this method, although it is possible to use a simple circuit, there is a deficiency that the sensor detects movement even when a curtain in the sensing range of the sensor shook by the wind. Moreover, a second method for determining whether the moving object is the television image is applicable. Here, an image recognition technology such as face-recognition technology for a digital camera is cited. Moreover, a third method for determining whether the television image and the image imaged by the image sensor are identical. A technology in shooting games, where the score is added when it is determined whether the image imaged by an image sensor provided to a gun is identical with an image as a target, is applicable. The ‘second signal transmission circuit’ has a function of ‘transmitting a 3D image display signal to display a 3D image, when the image movement determination circuit has determined that the image has included the movement’. The ‘second 3D image display signal reception circuit’ has a function of ‘receiving the 3D image display signal’, and a ‘second 3D image display circuit’ has a function of ‘displaying the 3D image when the second 3D image display signal reception circuit has received the 3D image display signal’.

It has been described in the second embodiment that the 3D image display signal includes the instantaneous type and the continuous type, and that the 3D image display signal and the non-3D image display signal may be used. Moreover, the configurations of the second signal transmission circuit, the second 3D image display signal reception circuit, and the second 3D image display circuit in the above case have also been described. Moreover, the configuration, where the open/close action of the shutter of the 3D image viewing glasses is synchronized with the image display of the second image display apparatus, and the configuration, where the switching the 3D/non-3D image in the second image display apparatus and the control of power of the 3D image viewing glasses are simultaneously executed, have been described in the second embodiment.

### Processing Flow of Third Embodiment

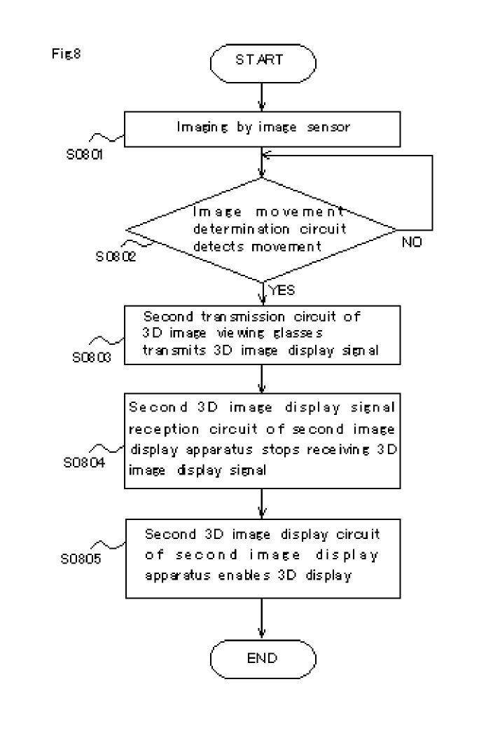

FIG. 8 is a flowchart showing processes in the image display system of the third embodiment. When the viewer wears the 3D image viewing glasses and faces the television screen, the image sensor provided in front of the glasses images the television screen (step S0801), and when the image movement determination circuit determines that there is movement (step S0802), the second signal transmission circuit of the 3D image viewing glasses transmits the 3D image display signal (step S0803). Subsequently, the second 3D image display signal reception circuit of the second image display apparatus receives the 3D image display signal (step S0804), and the second 3D image display circuit of the second image display apparatus enables 3D display (step S0805).

According to the third aspect, the image display system, where the switching of the 3D/non-3D image of the television screen is automatically executed just by wearing/removing the 3D image viewing glasses and facing the television screen, is provided.

### Fourth Embodiment

### Concept of Fourth Embodiment

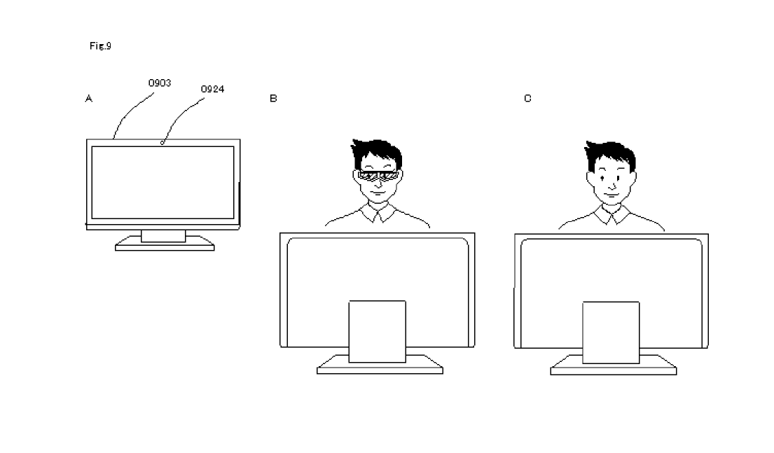

FIG. 9 is a conceptual diagram of an image display system of a fourth embodiment. In the image display system of the fourth embodiment, a television 0903 comprises an image sensor 0924 in front thereof (FIG. 9A). When a viewer wears the 3D image viewing glasses, the image sensor of the television recognizes the 3D image viewing glasses, thereby switching of the image on the screen to the 3D image (FIG. 9B). When the viewer views without wearing the 3D image viewing glasses, the image sensor of the television cannot recognize the 3D image viewing glasses, thereby switching of the image on the screen to the non-3D image (FIG. 9C).

### Configuration of Fourth Embodiment

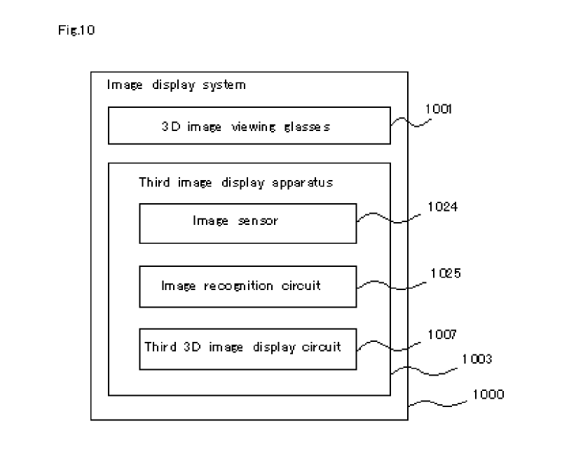

FIG. 10 is a functional block diagram of the image display system of the fourth embodiment. An ‘image display system’ 1000 of the fourth embodiment comprises ‘3D image viewing glasses’ 1001, and a ‘third image display apparatus’ 1003. The third image display apparatus further comprises an ‘image sensor’ 1024, and an ‘image recognition circuit’ 1025, and a ‘third 3D image display circuit’ 1007.

The ‘image sensor’ is the same as that of the third embodiment. The ‘image recognition circuit’ has a function of ‘determining whether an image imaged by the image sensor includes identification information of the 3D image viewing glasses’. The ‘identification information of the 3D image viewing glasses’ may be information of entire or partial shape, color or gloss, or combination thereof regarding the 3D image viewing glasses, or may be a code such as a barcode indicated on the front of the 3D image viewing glasses. Various technologies for determining whether a specific object such as human face is included in an image have been known, and utilized for digital camera etc, and such image recognition technologies are applicable to the image display system. The ‘third 3D image display circuit’ has a function of ‘displaying the 3D image, when the image recognition circuit has determined that the image has included the identification information of the 3D image viewing glasses’. The determination as to whether the identification information of the 3D image viewing glasses is included in the image is continuously or periodically executed. The third 3D image display circuit displays the non-3D image, when the image recognition circuit has determined that the image has not included the identification information of the 3D image viewing glasses’.

Moreover, the configuration, where the open/close action of the shutter of the 3D image viewing glasses is synchronized with the image display of the third image display apparatus, and the configuration, where the switching the 3D/non-3D image in the third image display apparatus and the control of power of the 3D image viewing glasses are simultaneously executed, have been described in the second embodiment.

### Processing Flow of Fourth Embodiment

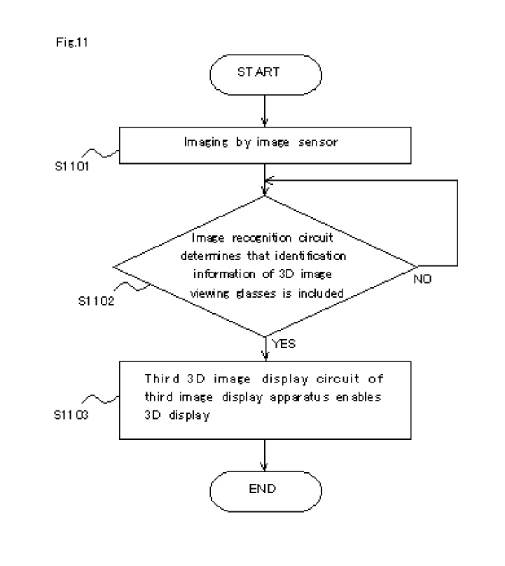

FIG. 11 is a flowchart showing processes in the image display system of the fourth embodiment. When the viewer wears the 3D image viewing glasses and faces the television screen, the image sensor provided in front of the television images the viewer wearing the 3D image viewing glasses (step S1101). Subsequently, when it is detemined by the image recognition circuit that the identification information of the 3D image viewing glasses is included (step S1102), the third 3D image display circuit enables the 3D image display (step S1103).

According to the fourth aspect, the image display system, where the switching of the 3D/non-3D image of the television screen is automatically executed just by wearing or not wearing the 3D image viewing glasses and facing to the television screen, is provided.

### Fifth Embodiment

### Concept of Fifth Embodiment

In the image display system of the fifth embodiment, the 3D image viewing glasses have arms, and when opening the arms, the display of the television is switched to the 3D image, and when closing the arms, the display of the television is switched to the non-3D image.

### Configuration of Fifth Embodiment

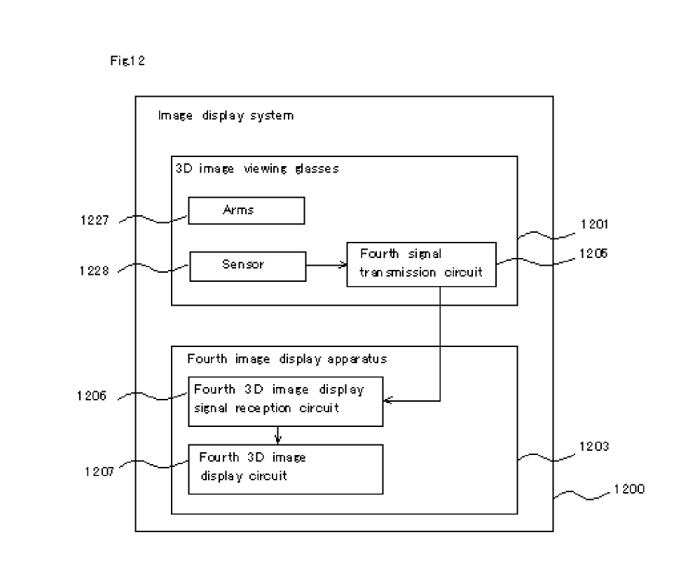

FIG. 12 is a functional block diagram of the image display system of the fifth embodiment. An ‘image display system’ 1200 of the fifth embodiment comprises ‘3D image viewing glasses’ 1201, and a ‘fourth image display apparatus’ 1203. The 3D image viewing glasses comprise a ‘arms’ 1227, a ‘sensor’ 1228, and a ‘fourth signal transmission circuit’ 1205. The fourth image display apparatus further comprises a ‘fourth 3D image display signal reception circuit’ 1206, and a ‘fourth 3D image display circuit’ 1207.

The ‘arms’ are worn over the ears for fixing the glasses on the head, and are connected by hinges to the both sides of the body of the 3D image viewing glasses. The ‘sensor’ is placed at least one of connection units of the two arms, and has a function of ‘detecting whether the arms are closed’.

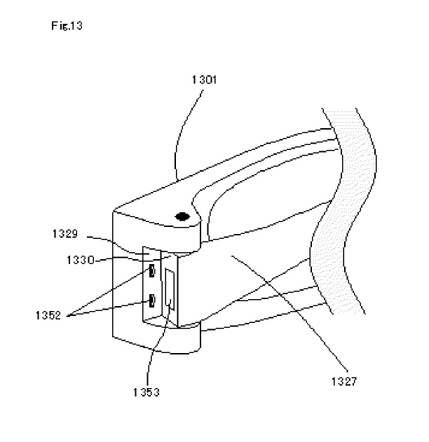

FIG. 13 is an enlarged view of connection terminals of arms of a 3D image viewing glasses of the fifth embodiment. The arms 1327 connected to the 3D image viewing glasses 1301 using the hinges can open or close. FIG. 13 shows a state that the arms are closed, and an internal-side surface A1329 of the 3D image viewing glasses and an internal-side surface B1330 of the arm are disconnected. When viewing the 3D image, the viewer of the 3D image opens the arms of the 3D image viewing glasses, and wears the glasses on the head. When opening the arms, the surfaces A and B are in closely contact with each other, and the arms cannot open more than necessity. As to the sensor, a pair of electrodes 1352 is provided at the surface A, and when the electrodes are in contact with a metal portion 1353 provided on the surface B, and energizing between the electrodes may be detected. Moreover, a magnet is provided on the surface B, and a magnet sensor is provided on the surface A, so that the magnet sensor may detect the magnet when they are in contact with each other.

The ‘fourth signal transmission circuit’ has a function of ‘transmitting a 3D image display signal to display a 3D image, when the sensor has detected that the arms have not been closed’. The ‘fourth 3D image display signal reception circuit’ of the fourth image display apparatus has a function of ‘receiving the 3D image display signal’, and the ‘fourth 3D image display circuit’ has a function of enabling ‘displaying the 3D image when the fourth 3D image display signal reception circuit has received the 3D image display signal’.

It has been described in the second embodiment that the 3D image display signal includes the instantaneous type and the continuous type, and that the 3D image display signal and the non-3D image display signal may be used. Moreover, the configurations of the fourth signal transmission circuit, the fourth 3D image display signal reception circuit, and the fourth 3D image display circuit in the above case have also been described.

Moreover, the configuration, where the open/close action of the shutter of the 3D image viewing glasses is synchronized with the image display of the fourth image display apparatus, and the configuration, where the switching the 3D/non-3D image in the fourth image display apparatus and the control of power of the 3D image viewing glasses are simultaneously executed, have been described in the second embodiment.

### Processing Flow of Fifth Embodiment

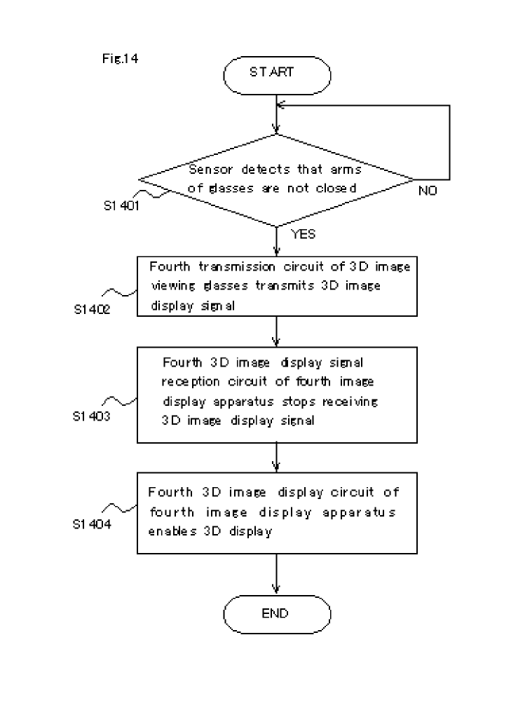

FIG. 14 is a flowchart showing processes in the image display system of the fifth embodiment. When the viewer opens the arms of the 3D image viewing glasses upon wearing the 3D image viewing glasses, the sensor detects that the arms are opened (step S1401), the fourth signal transmission circuit transmits the 3D image display signal (step S1402). Subsequently, the fourth 3D image display signal reception circuit of the fourth image display apparatus receives the 3D image display signal (step S1403), and the fourth 3D image display circuit of the fourth image display apparatus enables 3D display (step S1404).

According to the fifth aspect, the image display system, where the switching of the 3D/non-3D image of the television screen is automatically executed just by opening/closing the arms of the 3D image viewing glasses, which is an action naturally done upon wearing/removing the glasses, is provided.

### DESCRIPTION OF REFERENCE NUMERALS

0101 3D image viewing glasses

0102 Seat for glasses

0103 First image display apparatus

1. An image display system, comprising:
3D image viewing glasses;
a seat for glasses for placing the 3D image viewing glasses; and
a first image display apparatus for viewing via the 3D image viewing glasses,
wherein the seat for glasses further comprises
a detection circuit, detecting whether the 3D image viewing glasses have been placed, and
a first signal transmission circuit, transmitting a 3D image display signal for displaying the 3D image when the detection result by the detection circuit indicates that the 3D image viewing glasses have not placed, and
wherein the first image display apparatus further comprises
a first 3D image display signal reception circuit, receiving the 3D image display signal, and
a first 3D image display circuit, displaying the 3D image when the first 3D image display signal reception circuit has received the 3D image display signal.

2. The image display system according to claim 1,
wherein the 3D image viewing glasses have a liquid-crystal shutter, and further comprises
a first connection terminal for electric connection to the seat for glasses when the 3D image viewing glasses are placed, and
a chargeable battery being connected with the first connection terminal, and
wherein the seat for glasses further comprises
a second connection terminal for electric connection to the first connection terminal of the 3D image viewing glasses, and
a charging circuit, supplying power to the battery when the connection between the first connection terminal and the second connection terminal is established, and
wherein the detection circuit detects that the 3D image viewing glasses are placed when the connection between the first connection terminal and the second connection terminal is established.

3-5. (canceled)
